(19) United States
(12) Patent Application Publication
(10) Pub. No.: US 2018/0298670 A1
(43) Pub. Date: Oct. 18, 2018

(54) VEHICLE HANDS-FREE CLOSURE INITIALIZER

(71) Applicant: FORD GLOBAL TECHNOLOGIES, LLC, Dearborn, MI (US)

(72) Inventors: Jason Shomsky, Brownstown, MI (US); John W. Jensen, Canton, MI (US); Mahmoud Yousef Ghannam, Canton, MI (US); Howard E. Churchwell, II, Monroe, MI (US)

(21) Appl. No.: 15/487,030

(22) Filed: Apr. 13, 2017

(51) Int. Cl. E05F 15/77; B60R 25/01; B60R 25/24; E05F 15/73; E05F 15/79

(52) U.S. Cl. CPC E05F 15/77; B60R 25/01; E05Y 2900/532; E05F 15/73; E05F 15/79; B60R 25/24

(57) ABSTRACT

A hands-free power closure system for a vehicle includes a a power-operated closure, a proximity sensor system defining a predetermined sensing range, and a remote entry device adapted to store a power-operated closure open command in memory for a predetermined time period. The system further includes a power-operated closure control module in operative communication with the remote entry device, the proximity sensor system, and the power-operated closure. The remote entry device processor is adapted to disable the power-closure open command on expiration of the predetermined time period.

### TECHNICAL FIELD

This disclosure relates generally to power closure systems for motor vehicles. More particularly, this disclosure relates to a power liftgate system and associated methods for operation thereof whereby a user may automatically cause opening of the power liftgate within a predetermined time of issuing a “liftgate open” command via a remote entry device.

### BACKGROUND

Hands-free systems for opening/closing various power-operated closures such as vehicle liftgates are known in the art. Hands-free systems offer great convenience for users, allowing persons carrying items or who may be physically impaired to more easily open closures such as liftgates.

Such systems often require user intervention, for example positioning a hand or foot before a proximity sensor to actuate a liftgate power system. The response time of the hands-free power liftgate system, however, can be an issue. If the system does not respond by opening the liftgate in what is perceived to be a timely manner by the user, the user may again issue the necessary command, potentially negating the original “liftgate open” command. This can be incorrectly perceived by the consumer as a malfunction in the system, resulting in consumer dissatisfaction and potentially unnecessary service calls.

There is accordingly identified a need in the art for improvements to hands-free power closure systems.

### SUMMARY

In accordance with the purposes and benefits described herein, in one aspect of the disclosure a hands-free power closure system for a vehicle is provided, comprising a power-operated closure, a proximity sensor system defining a predetermined sensing range, and a remote entry device adapted to store a power-operated closure open command in memory for a predetermined time period. The system further includes a power-operated closure control module in operative communication with the remote entry device, the proximity sensor system, and the power-operated closure. In embodiments, the power-operated closure may be a liftgate and the remote entry device is one or more of a keyfob, a passive entry/passive start device, and a mobile device provided with phone-as-a-key logic.

The remote entry device comprises a processor with memory, storage, and a timer. The timer is adapted to define the predetermined time period. The power-operated closure control module may be adapted to receive the power-operated closure open command on detection of the remote entry device within the predetermined sensing range. The remote entry device processor is adapted to disable the power-closure open command on expiration of the predetermined time period. Likewise, the power-operated closure control module is adapted to close the power-operated closure on exit of the remote entry device from the predetermined sensing range. In embodiments, the power-operated closure control module is further adapted to close the power-operated closure on detecting a vehicle ignition on condition.

In another aspect of the disclosure, a method for controlling a vehicle hands-free power closure system as described above is provided. The method includes providing a power-operated closure control module adapted to act on the power-closure open command only on detection of an authenticated remote entry device within the predetermined sensing range. The method includes providing a remote entry device comprising a processor, memory, storage, and a timer as described above, and adapting the timer to determine a predetermined time period of storage of the power-closure open command. The method further includes a step of by the processor, disabling the power-closure open command if the remote entry device is not detected within the predetermined sensing range within the predetermined time period. The method may further include a step of, by the power-operated closure control module, causing the power-operated closure to close on exit of the remote entry device from the predetermined sensing range.

In the following description, there are shown and described embodiments of a hands-free power closure system and attendant methods. As it should be realized, the systems and methods are capable of other, different embodiments and their several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed hands-free power closure system and methods, and together with the description serve to explain certain principles thereof. In the drawing:

FIG. 1 shows in block diagram form a hands-free power closure system according to the present disclosure

FIG. 2 shows a vehicle including the hands-free power closure system of FIG. 1; and

FIG. 3 depicts a method of operation of the hands-free power closure system of FIG. 2.

Reference will now be made in detail to embodiments of the disclosed hands-free power closure system and methods, examples of which are illustrated in the accompanying drawing figures.

### DETAILED DESCRIPTION

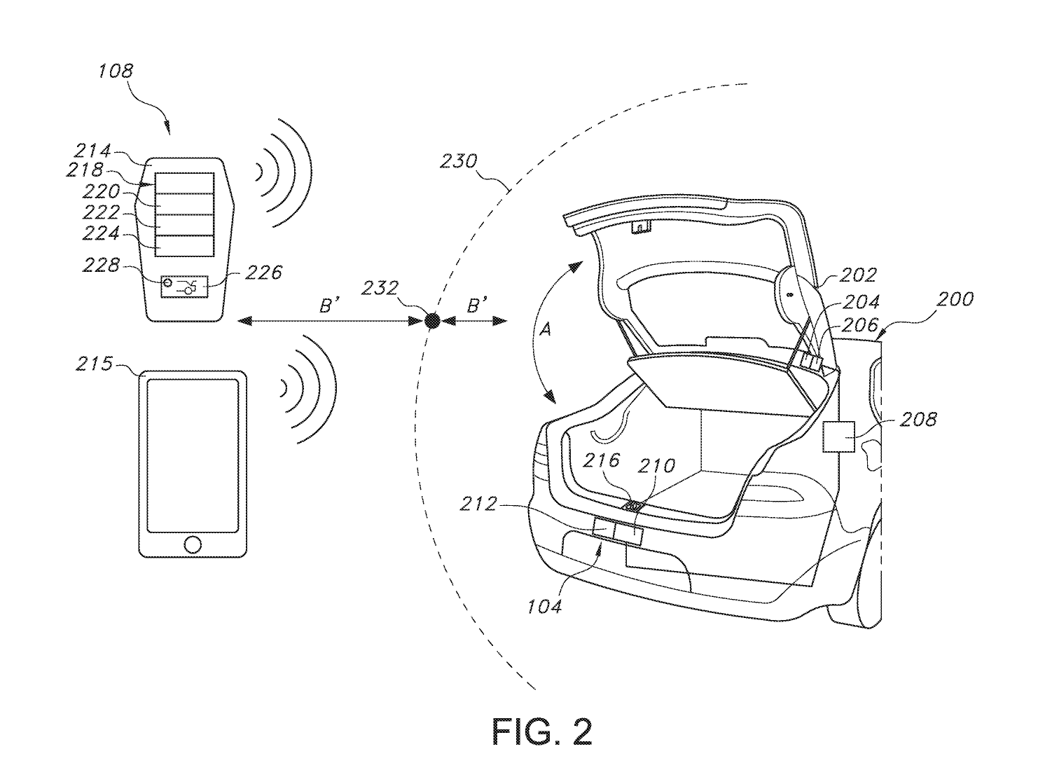

Preliminarily, the present disclosure is directed to a hands-free power closure system and methods used in association with a power-operated, top-hinged and rear-mounted vehicle liftgate as shown in FIG. 2. However, it will be readily appreciated by the skilled artisan that the described system is easily adaptable to any power-operated door or closure, including without intending any limitation sliding doors, top-hinged vehicle-up-down raising or “gull-wing” doors, hatch-back doors, trunks, and others. Accordingly, the present description should not be taken as limiting in that regard.

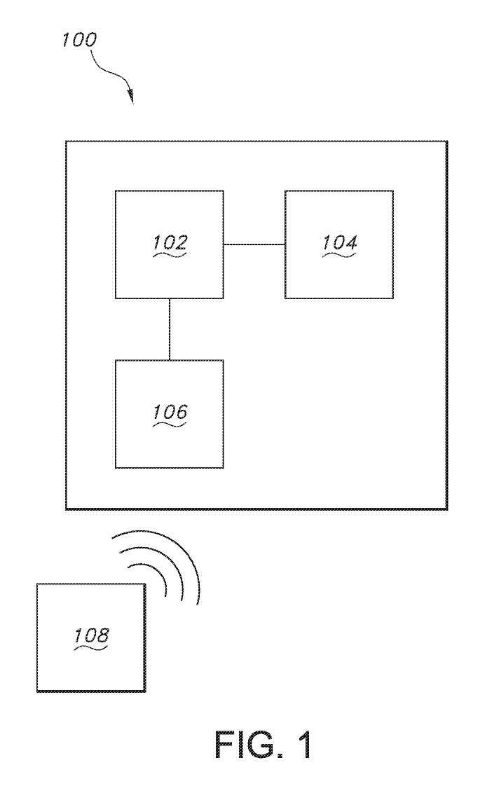

FIG. 1 depicts at a high level and in block diagram form a hands-free power closure system 100 according to the present disclosure. The hands-free power closure system 100 includes a power-operated closure 102, a remote entry device detector system 104 defining as will be described below a predetermined sensing range, and a power-operated closure control module 106, all of which may be in operative communication with other elements of the hands-free power closure system 100. A remote entry device 108 is provided, which as will be described is adapted to store a power-operated closure open command for a predetermined period of time.

FIG. 2 shows a vehicle 200 including the hands-free power closure system 100 of FIG. 1. The vehicle 200 includes a rear-mounted liftgate 202 hingedly connected to a portion of the vehicle body. The liftgate 202 includes a power-operating system including a motor 204 operatively connected whereby the liftgate may be translated (see arrow A) between an open position as shown in the drawing and a closed position. The motor 204 may include a dedicated liftgate motor controller 206, may be operatively connected to a central controller 208 such as the Body Control Module (BCM), or both. This operative connection may be wireless, or via vehicle 200 on-board wired networks such as the CAN bus, LAN, and others.

Vehicle 200 further includes a remote entry device detector system 104 which may be provided by a proximity sensor system 210. The proximity sensor system 210 is likewise in operative communication with one or both of the liftgate motor controller 206 and/or the central controller 208. The basic operative principles such proximity sensor systems 210 in conjunction with a power-operated closure such as liftgate 202 are known in the art, and do not require extensive discussion herein. However, at a high level such systems 210 may include one or more suitable proximity sensors such as ultrasonic sensors, radar or LIDAR-based sensors, and others configured to detect an object disposed within a predetermined distance.

Separately or in conjunction with the proximity sensor system 210, a suitable receiver 212 may be provided, configured to recognize a unique identification code transmitted by a remote entry device 108. As is known, such remote entry devices 108 are used to control latching/unlatching and/or opening/closing of vehicle power locks 216 and/or power closures such as liftgate 202. A variety of remote entry devices 108 are known in the art, including without intending any limitation keyfobs 214, mobile devices 215 configured with phone-as-a-key logic, passive entry/passive start devices (so-called “smartkeys”), and others.

Using the keyfob 214 as an example, as is known the remote entry device 108 may include one or more processors 218 provided with one or more memories 220 and storage 222. The keyfob 214 further includes a timer 224 associated with the processor 218. An actuator 226 may be provided for issuing a “liftgate open” and/or a “liftgate close” command. For reasons discussed below, the keyfob 214 may further include a “liftgate open command” indicator, such as a visible light 228.

One or both of the proximity sensor system 210 and the receiver 212 may be configured to detect the keyfob 214 at a predetermined distance from the vehicle 200, such as by configuring a predetermined sensing range 230. The predetermined sensing range 230 may be provided by default by the manufacturer and/or may be configurable by a user as desired. When the keyfob 214 breaches the predetermined sensing range 230 such as at point 232 (see arrows B, B′), the proximity sensor system 210 and/or receiver 212 are configured to recognize the device. That is, as is known, the proximity sensor system 210 and/or receiver 212 receive the unique identification code transmitted by the remote entry device 214, authenticate it against a code or list of codes stored in memory in, for example, the central controller 208, and if authenticated will accept commands therefrom. Likewise, the proximity sensor system 210 and/or receiver 212 are configured to detect when the keyfob 214 exits the predetermined sensing range 230. Such technology is known in the art, for example for actuating vehicle 200 headlights on detection of a keyfob 214.

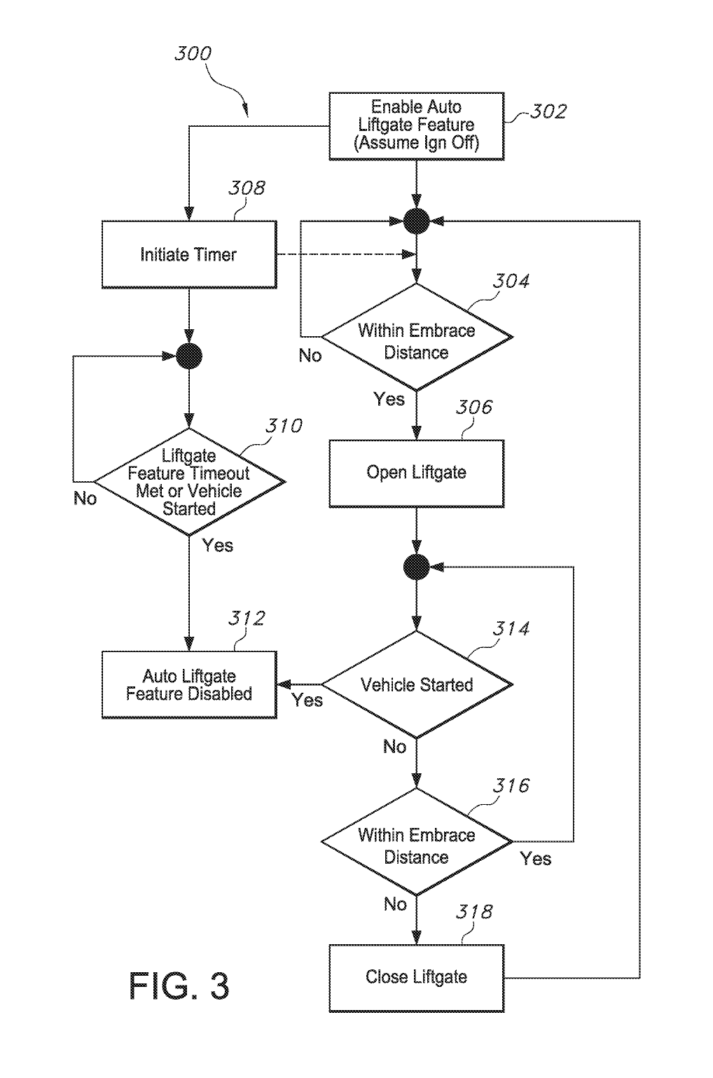

Operation of the hands-free power closure system discussed above will now be described. With reference to FIG. 3, a method 300 for operating the system is depicted in decision tree form. At step 302, a user actuates a “liftgate open” command, such as by pressing actuator 226 on keyfob 214. If the proximity sensor system 210 and/or receiver 212 determine that the user is holding the keyfob 214 within the predetermined sensing range 230 when actuator 226 is pressed (step 304), at step 306 the power liftgate 202 is opened.

On the other hand, if the proximity sensor system 210 and/or receiver 212 determine that the user is not holding the keyfob 214 within the predetermined sensing range 230 when actuator 226 is pressed, at step 308 the keyfob processor 218 initiates timer 224, and the predetermined time period begins to count down. In an embodiment, the predetermined time period may be set to five minutes. However, any suitable time frame may be selected. If the keyfob 214 is determined by the proximity sensor system 210 and/or receiver 212 to have entered the predetermined sensing range 230 prior to expiration of the predetermined time period, the power liftgate 202 is opened (step 306).

A variety of “liftgate open” command counters are contemplated. For example, the liftgate motor controller 206 and/or the central controller 208 may periodically determine whether the predetermined time period has expired and/or whether a “vehicle ignition on” condition exists (step 310). If not, the process proceeds as described above. If so, at step 312 the “liftgate open” command is disabled by the keyfob processor 218.

Likewise, after a successful “liftgate open” command implementation (step 306), if it is determined by the liftgate motor controller 206 and/or the central controller 208 that a “vehicle ignition on” condition exists (step 314), the “liftgate open” command is disabled (step 312). In turn, the liftgate motor controller 206 and/or the central controller 208 may periodically query the proximity sensor system 210 and/or receiver 212 to determine whether the keyfob 214 remains within the predetermined sensing range 230 (step 316). If so, no action is taken. If the user has taken the keyfob 214 or other remote entry device 108 outside of the predetermined sensing range 230, the liftgate motor controller 206 and/or the central controller 208 will cause the motor 204 to translate the liftgate 202 to the closed position (step 318).

As will be appreciated, the described systems and methods provide great convenience to the user. A user burdened by packages, a child, etc., or alternatively a physically impaired user, can issue the “liftgate open” command as described above prior to reaching her vehicle/entering the predetermined sensing range 230, and this “liftgate open” command will be stored for a predetermined time period such as five minutes. As long as the user reaches her vehicle within that predetermined time period, the liftgate 202 will automatically open without requiring any further action by the user. On the other hand, if the user does not reach her vehicle within the predetermined time period, no action will be performed on the liftgate. Equally, if a user walks away from her vehicle and forgets to close the liftgate 202, the hands-free power closure system 100 will as described above automatically close and latch/lock the liftgate 202, thus improving security.

As will be appreciated, the above controller queries may be accomplished by resort to a look-up table stored in memory, e.g. by the liftgate motor controller 206 and/or the central controller 208. A representative look up table is presented below in Table 1, allowing the designated controller to map various remote entry device 108 status inputs and vehicle ignition inputs to a required command issued to the liftgate 202 power operating system.

TABLE 1
Liftgate command look-up table.

| REMOTE ENTRY DEVICE | | |
|---|---|---|
| IN PREDETERMINED | VEHICLE IGNITION | LIFTGATE |
| SENSING RANGE? | STATUS? | COMMAND |
| NO | OFF | CLOSE |
| NO | ON | CLOSE |
| YES | OFF | OPEN |
| YES | ON | CLOSE |

Obvious modifications and variations are possible in light of the above teachings. All such modifications and variations are within the scope of the appended claims when interpreted in accordance with the breadth to which they are fairly, legally and equitably entitled.

What is claimed:

1. A hands-free power closure system for a vehicle, comprising:
a power-operated closure;
a proximity sensor system defining a predetermined sensing range; and
a remote entry device adapted to store a power-operated closure open command in memory for a predetermined time period.

2. The hands-free power closure system of claim 1, further including a power-operated closure control module in operative communication with the remote entry device, the proximity sensor system, and the power-operated closure.

3. The hands-free power closure system of claim 1, wherein the power-operated closure is a liftgate.

4. The hands-free power closure system of claim 1, wherein the remote entry device is one or more of a keyfob, a passive entry/passive start device, and a mobile device provided with phone-as-a-key logic.

5. The hands-free power closure system of claim 2, wherein the remote entry device comprises a processor with memory, storage, and a timer.

6. The hands-free power closure system of claim 5, wherein the timer is adapted to define the predetermined time period.

7. The hands-free power closure system of claim 6, wherein the power-operated closure control module is adapted to receive the power-operated closure open command on detection of the remote entry device within the predetermined sensing range.

8. The hands-free power closure system of claim 6, wherein the remote entry device processor is adapted to disable the power-operated closure open command on expiration of the predetermined time period.

9. The hands-free power closure system of claim 8, wherein the power-operated closure control module is adapted to close the power-operated closure on exit of the remote entry device from the predetermined sensing range.

10. The hands-free power closure system of claim 9, wherein the power-operated closure control module is further adapted to close the power-operated closure on detecting a vehicle ignition on condition.

11. A vehicle including the hands-free power closure system of claim 1.

12. A method for controlling a vehicle hands-free power closure system, comprising:
providing a proximity sensor system defining a predetermined sensing range;
providing a remote entry device adapted to store a power-operated closure open command in memory for a predetermined time period; and
providing a power-operated closure control module adapted to act on the power-operated closure open command only on detection of the remote entry device within the predetermined sensing range.

13. The method of claim 12, further including providing a power-operated closure control module in operative communication with the remote entry device, the proximity sensor system, and the power-operated closure.

14. The method of claim 12, further including providing the remote entry device configured as one or more of a keyfob, a passive entry/passive start device, and a mobile device provided with phone-as-a-key logic.

15. The method of claim 13, further including providing the remote entry device comprising a processor with memory, storage, and a timer.

16. The method of claim 15, including adapting the timer to determine the predetermined time period of storage of the power-operated closure open command.

17. The method of claim 16, including, by the processor, transmitting the power-operated closure open command to the power-operated closure control module only on detection of the remote entry device within the predetermined sensing range.

18. The method of claim 16, including, by the processor, disabling the power-operated closure open command if the remote entry device is not detected within the predetermined sensing range within the predetermined time period.

19. The method of claim 17, including, by the power-operated control module, causing the power-operated closure to close on exit of the remote entry device from the predetermined sensing range.

20. The method of claim 19, including, by the power-operated control module, closing the power-operated closure on detecting a vehicle ignition on condition.
